(19) United States
(12) Patent Application Publication
(10) Pub. No.: US 2019/0321763 A1
(43) Pub. Date: Oct. 24, 2019

(54) A CYCLONIC ADAPTOR

(71) Applicant: Primetals Technologies, Limited, London (GB)

(72) Inventors: David MASON, Peterlee (GB); Nicholas MYERS, Redcar (GB)

(21) Appl. No.: 16/471,079

(22) PCT Filed: Dec. 21, 2017
(86) PCT No.: PCT/EP2017/084004

§ 371 Date: Jun. 19, 2019

(30) Foreign Application Priority Data
Dec. 22, 2016 (GB) 1622048.5

(51) Int. Cl. B01D 45/16; B04C 5/28

(52) U.S. Cl. CPC B01D 45/16; B04C 5/04; B04C 5/28

(57) ABSTRACT

A cyclonic adaptor for fitting to a gravity-based dustcatcher (100) for a metallurgical processing plant: at least one input pipe (203), and a cyclone chamber (205) having a curved inner surface for guiding a gas flow within the interior of the cyclone chamber in a cyclonic manner. The cyclone chamber (205) having an exit in fluid communication with an outlet of the dustcatcher in use, wherein the at least one input pipe (203) has a first end in fluid communication with an inlet (104) of the dustcatcher (100) in use and the inlet pipe is adapted to receive exhaust gas containing solid particles from a metallurgical processing plant from the inlet (104) of the dustcatcher (100), and extends from the first end to a second end positioned in fluid communication with the interior of the cyclone chamber (205), wherein the second end is arranged to direct the exhaust gas in an at least primarily tangential direction with respect to the curved inner surface of the cyclone chamber such that the exhaust gas entering the cyclone chamber (205) flows in a cyclonic manner in order to remove solid particles from the exhaust gas before flowing through the exit, and wherein the cyclone chamber (205) is adapted to be housed within an interior volume of the dustcatcher (100).

### CROSS-REFERENCE TO RELATED APPLICATIONS

The present application is a 35 U.S.C. §§ 371 national phase conversion of PCT/EP2017/084004, filed Dec. 21, 2017, the contents of which are incorporated herein by reference which claims priority of Great Britain Application No. 1622048.5, filed Dec. 22, 2016, the contents of which are incorporated by reference herein. The PCT International Application was published in the English language.

### FIELD OF THE INVENTION

The present invention is directed to a cyclonic adaptor for removing particulate matter such as dust from a gas flow. The invention has particular application for the processing of exhaust (off-) gas from a metallurgical processing plant. Examples of such metallurgical processing plants include metallurgical furnaces (for example a Blast Furnace or a Direct Reduction Iron Furnace) and Sinter Plants.

### BACKGROUND TO THE INVENTION

A metallurgical processing plant such as an iron-producing blast furnace plant typically comprises the furnace itself together with a gas cleaning system for treating the off-gas from the furnace. Most gas cleaning systems comprise a primary cleaning stage and a secondary fine cleaning stage. The object of the primary cleaning stage is to remove coarse dust particles from the off-gas before it enters the fine cleaning stage (secondary), which is typically a wet scrubber, electrostatic precipitator or a dry type filter.

Traditionally, the preliminary cleaning stage would be carried out by a gravity-based dustcatcher. Such a dustcatcher typically comprises a large diameter separation chamber into which off-gas from the furnace is fed via a gas pipe called a downcomer. The separation chamber has a much larger diameter than the downcomer, and a gas outlet is positioned in a top section of the separation chamber. Off-gas is fed, typically axially with respect to the dustcatcher, into the top of the separation chamber and experiences a large decrease in velocity due to the increase in cross-section from flowing from the downcomer into the separation chamber. Furthermore, as the outlet is situated in the top section of the separation chamber, the off-gas must reverse its direction of flow at the bottom of the separation chamber in order to flow out through the outlet. The reduction in flow velocity and the reversal of the direction of flow causes coarse dust particles to separate from the gas flow due to gravity, and these are collected in a funnel-shaped hopper at the bottom of the dustcatcher.

However, conventional dustcatchers typically only have a dust-removal efficiency in the range of 30-65% This relatively poor dust removal efficiency of the dustcatcher affects the sizing and performance of the downstream units of the gas cleaning system such as the wet scrubber and slurry handling equipment.

There is therefore a need within the industry to improve the efficiency of the preliminary cleaning stage of a gas cleaning system, especially as improvements in furnace technology increase metal production efficiency, and therefore the volume of off-gas produced is increased.

More recently, cyclone technology has been utilized for the preliminary cleaning stage. Off-gas from the furnace is fed into a cyclone dust separator and dust particles are separated from the cyclonic gas flow due to centrifugal force before being collected in a funnel-shaped hopper at the bottom of the cyclone dust separator. Cyclone dust separators have extremely high dust removal efficiencies compared to conventional gravity-based dustcatchers. An example of such a cyclone dust separator is described in GB-A-2490188.

However, replacing a conventional dustcatcher with a cyclone dust separator is extremely costly and time intensive. The time taken to install a cyclone dust separator is of particular concern as the furnace will not be able to operate during the installation. Furthermore, there are significant layout considerations to be taken into account when installing a cyclone dustcatcher at a furnace site.

It is an object of the present invention to overcome these problems.

### SUMMARY OF THE INVENTION

In accordance with a first aspect of the present invention, there is provided a cyclonic adaptor for fitting to a gravity-based dustcatcher for a metallurgical processing plant, comprising: at least one input pipe, and; a cyclone chamber having a curved inner surface for guiding a gas flow within the interior of the cyclone chamber in a cyclonic manner. The cyclone chamber comprises an exit in fluid communication with an outlet of the dustcatcher in use, wherein; the at least one input pipe has a first end in fluid communication with an inlet of the dustcatcher in use and adapted to receive exhaust gas containing the particles from a metallurgical processing plant from the inlet of the dustcatcher, and extends from the first end to a second end positioned in fluid communication with the interior of the cyclone chamber. The second end is arranged to direct the exhaust gas in an at least primarily tangential direction with respect to the curved inner surface of the cyclone chamber such that the exhaust gas entering the cyclone chamber flows in a cyclonic manner in order to remove solid particles from the exhaust gas before flowing through the exit, and wherein; the cyclone chamber is configured to be housed within an interior volume of the dustcatcher.

The present invention overcomes the problems described above by providing a cyclonic adaptor that can be retro-fitted to an existing dustcatcher at a metallurgical furnace plant. This allows the mode of operation of the pre-existing dustcatcher to be changed from being gravity-based to being cyclone-based. Therefore the efficiency of the dust removal of the existing dustcatcher can be increased dramatically without the inconvenience of having to install a whole new cyclone dust separator. Not only will downtime of the metallurgical processing plant be reduced (as retro-fitting a cyclonic adaptor according to the invention will be much quicker than removing the existing dustcatcher and building a new dedicated cyclone dust separator), but the financial outlay will also be dramatically reduced. The cyclonic adaptor of the present invention is able to provide a dust removal efficiency of greater than 80%, even up to 100% and therefore at least equal to that of a dedicated standalone cyclone dustcatcher.

The cyclone chamber of the cyclonic adaptor is adapted to be housed within an interior volume of the dustcatcher. The cyclone chamber is housed such that it is completely contained within the interior volume of the dustcatcher. This placement of the cyclone chamber within the dustcatcher means that minimal extra space is used and advantageously means that no problems arise with regard to the cyclonic adaptor impacting other apparatus within the metallurgical processing plant, for instance downstream gas cleaning equipment. Housing the cyclone chamber within the interior volume also beneficially means that there are minimal adaptions required to the pre-existing dustcatcher and inlet.

The cyclonic adapter preferably comprises a single cyclone chamber. This advantageously increases ease of installation of the cyclonic adapter. Furthermore, use of a single cyclone chamber (as opposed to multiple cyclone chambers) ensures that there will be no detrimental imbalances of gas flow across multiple ones of such chambers, which may arise due to dust blockages for example.

The positioning of the cyclone chamber within the pre-existing dustcatcher is typically determined dependent on the existing set-up of the dustcatcher. Preferably, the cyclone chamber is positioned substantially coaxially with the inlet of the dustcatcher.

The cyclone chamber comprises an exit in fluid communication with an inlet of the dustcatcher in use. This may simply be an aperture or orifice in the cyclone chamber that allows exhaust gas from which solid particle have been removed to flow from the cyclone chamber to the outlet of the pre-existing dustcatcher. In preferred embodiments, the cyclonic adapter comprises an exit pipe having a first end positioned in fluid communication with the interior of the cyclone chamber and a second end in fluid communication with the outlet of the dustcatcher in use, and wherein the exit pipe forms the exit. Even more preferably, the second end of such an exit pipe is attachable to an outlet of the dustcatcher.

In some instances, the cyclone chamber, the at least one input pipe and the exit pipe (where one is used) are configured to be housed within an internal volume of the dustcatcher. In other words, the entirety of the cyclonic adaptor may be housed within an interior volume of the dustcatcher. This advantageously ensures that the retro-fitting of the cyclonic adaptor provides minimal impact to the metallurgical processing plant.

The at least one input pipe may be configured to comprise a portion that is external to the dustcatcher. Such an external portion advantageously allows ease of access to the at least one input pipe, for example to carry out maintenance procedures or to remove blockages.

The at least one input pipe has a first end adapted to receive exhaust gas containing solid particles from a metallurgical furnace and a second end arranged to direct the exhaust gas in an at least primarily tangential direction with respect to the curved inner surface of the cyclone chamber such that the exhaust gas entering the cyclone chamber flows in a cyclonic manner in order to remove solid particles from the exhaust gas. In other words, the at least one input pipe re-directs the exhaust gas that would have been introduced into the pre-existing dustcatcher in such a manner so as to provide cyclonic gas flow within the cyclone chamber. Typically the first end of the at least one input pipe is adapted to receive exhaust gas containing solid particles from a metallurgical furnace in an axial direction with respect to the cyclone chamber, and the at least one input pipe has a curved portion to direct the gas from the primarily axial direction with respect to the cyclone chamber to a primarily tangential direction with respect to the cyclone chamber.

Such a curved portion changes the direction of the flow of off-gas in a gradual manner so as to reduce the chances of dust build-up and subsequent blockages within the input pipe.

However, the curvature of the at least one input pipe can be adapted to the positioning and direction of the pre-existing inlet pipe (if for example it is not axial with respect to the dustcatcher) such that they are in fluid communication in order to introduce exhaust gas into the cyclone chamber in order to generate a cyclonic flow.

Similarly, in embodiments where the cyclonic adapter comprises an exit pipe, the exit pipe is shaped appropriately so as to cooperate with the outlet of the dustcatcher.

Preferably the cyclone chamber has an orifice at a lower end of the cyclone chamber distal from the second end of the at least one input pipe such that solid particles removed from the cyclonic gas flow are directed through the orifice of the cyclone chamber and are collected in an existing collection hopper of the pre-existing dustcatcher. However, it is envisaged that the cyclone chamber of the cyclonic adaptor may comprise its own dedicated collection hopper.

The cyclonic flow will tend to move downwards through the cyclone chamber due to gravity. However, preferably, the second end of the at least one input pipe is arranged to direct the exhaust gas along a direction vector having a principal component in a plane perpendicular to a main axis of the cyclone chamber and a component in a downwards direction with respect to a plane perpendicular to a main axis of the cyclone chamber. In other words, the second end of the at least one input pipe is directed downwards in order assist in generating a downwards-moving cyclonic flow.

Typically, the second end of the at least one input pipe is arranged to direct the exhaust gas along a direction vector angled downwards with respect to a plane perpendicular to a main axis of the cyclone chamber, wherein the angle of inclination of the direction vector with respect to the plane is less than or equal to 15°.

The at least one input pipe may generally have any cross-sectional geometry; however typically the second end of the at least one input pipe has a cross-section having a major axis and a minor axis. The major axis is longer than the minor axis and the major axis is parallel with a main axis of the cyclone chamber. This means that the second end of the at least one input pipe has a long aspect ratio in the direction of a main axis of the cyclone chamber. This advantageously means that as much exhaust gas as possible is introduced into the cyclone chamber close to the curved inner surface in order to maximise its angular momentum and generate an efficient cyclonic flow. The second end of the at least one input pipe preferably has a rectangular cross-section.

Advantageously, the second end of the at least one input pipe is positioned in fluid communication with the interior of the cyclone chamber substantially adjacent the curved inner surface of the cyclone chamber, and preferably abuts the curved inner surface of the cyclone chamber. Similarly to above, this positioning maximises the radial positioning of the exhaust gas introduced into the cyclone chamber and therefore its angular momentum.

The cyclonic adaptor generates a good cyclonic flow with the use of a single input pipe. However, the cyclonic adaptor may comprise two or more input pipes. In such a case the second ends of the input pipes are preferably arranged to direct the exhaust gas in different directions that cooperate with each other such that the exhaust gas entering the cyclone chamber flows in a cyclonic manner. For example, in the case of two input pipes, their respective second ends would preferably be substantially opposed through 180° to each other and laterally spaced apart by a distance substantially equal to the diameter of the cyclone chamber. Introducing the exhaust gas in such a manner generates an efficient cyclonic flow. Similarly, in the case of three input pipes, these may be arranged at 120° to each other and four input pipes would be arranged at 90° to each other.

Typically the exit is substantially co-axial with the cyclone chamber. In preferred embodiments where the cyclonic adapter comprises an exit pipe, the first end of the exit pipe is substantially co-axial with the cyclone chamber. This is beneficial as the downwards-travelling cyclonic flow of exhaust gas within the cyclone chamber is reflected upwards at the lower end of the cyclone chamber and the upwards-travelling exhaust gas flows through the centre of the downward-travelling flow. The reflected exhaust gas travelling upwards along the centre of the cyclone chamber then subsequently flows into the first end of the co-axial exit pipe. This arrangement allows for a compact cyclonic adaptor. Other arrangements of the exit pipe with respect to the cyclone chamber are envisaged however dependent upon the specifications of the pre-existing dustcatcher.

Typically, the first end of the exit pipe (where used) is positioned below the second end of the at least one input pipe, in order to ensure that exhaust gas entering the cyclone chamber does not flow directly into the exit pipe before forming a cyclonic flow.

In some embodiments where the cyclonic adapter comprises an exit pipe, the exit pipe comprises a first portion within the cyclone chamber, a wall of said first portion of the exit pipe comprising a plurality of orifices such that exhaust gas within the cyclone chamber may flow into the exit pipe through said orifices. In such an embodiment, exhaust gas entering the cyclone chamber may flow directly from the input pipe into the exit pipe without forming a cyclonic flow. This may advantageously allow for a smaller cyclone chamber to be used, as the size of the cyclone chamber is dependent upon the amount of gas forming a cyclonic flow. The orifices typically have a size of between 100 and 500 mm, preferably 200 mm, and may be arranged in a series of concentric circles around the exit pipe, or may be arranged in a spiral form.

Typically, the cyclone chamber comprises a substantially cylindrical part and a reflection part positioned at a lower end of the substantially cylindrical part and operable to direct the exhaust gas towards exit. The reflection part typically comprises a funnel-shaped portion having a continuously-decreasing diameter such that an end of the funnel-shaped portion distal from the at least one input pipe has a smaller diameter than an end of the funnel-shaped portion proximal to the at least one input pipe, and wherein the funnel-shaped portion further comprises an orifice at the distal end through which solid particles removed from the exhaust gas are guided. It is well-known that a funnel-shaped geometry will cause reflection of a cyclone flowing into the funnel. Advantageously, the orifice at the distal end of the funnel-shaped portion (in other words at the bottom of the cyclone chamber) allows removed dust to fall under gravity out of the cyclone chamber and into the pre-existing collection hopper of the pre-existing dustcatcher.

Particularly preferably, the reflection part comprises a cyclone shedder, preferably in the form of a conical member. The cyclone shedder assists in reflecting the cyclonic gas flow back upwards along the centre of the cyclone chamber. This advantageously allows the length of the cyclone chamber to be reduced, thereby minimising the extent to which the cyclonic adaptor extends within the pre-existing dustcatcher. This is of particular consideration if the collection hopper of the pre-existing dustcatcher is being used to store the dust removed from the off-gas, as if the cyclonic adaptor extends too far into the dustcatcher, the storage capability of the collection hopper is reduced, therefore reducing the amount of time the metallurgical furnace can operate before dust has to be removed.

Preferably the cyclone shedder is co-axial with the substantially cylindrical part and the reflection part. This is particularly beneficial if the exit or exit pipe is co-axial with the cyclone chamber as this allows for a compact cyclonic adaptor.

Although a cyclone chamber having a substantially cylindrical part and a reflection part has been described above, other geometries of the cyclone chamber are envisaged. For example, the cyclone chamber may comprise a substantially funnel-shaped chamber having a continuously-decreasing diameter such that an end of the cyclone chamber distal from the at least one input pipe has a smaller diameter than an end of the cyclone chamber proximal to the at least one input pipe, and wherein the funnel-shaped chamber further comprises an orifice at the distal end through which solid particles removed from the exhaust gas are guided. Such a cyclone chamber may also preferably comprise a cyclone shedder located within the cyclone chamber.

Preferably the interior surface of the at least one input pipe comprises a wear resistant lining. It is particularly beneficial to position the wear resistant lining at the curved portion of the at least one input pipe, where solid particles within the exhaust gas are forced towards the interior surface. The use of a wear-resistant lining advantageously minimises wear of the cyclonic adaptor. The wear-resistant lining can be metallic or non-metallic and preferably comprises alumina ceramic.

The cyclonic adaptor dramatically increases the efficiency of the pre-existing dustcatcher such that smaller particles are able to be filtered out of the exhaust gas as compared with the pre-existing gravity-based dustcatcher. The “dry dust” filtered out may be recycled back into the metallurgical processing plant. However, it has been found that zinc, which is undesirable to be recycled in this way, is prevalent on particles having a smaller diameter than 20 μm which are now able to be removed from the off-gas by the cyclonic adaptor. Preferably therefore, the cyclonic adaptor may further comprise at least one bypass pipe having a first end in fluid communication with the cyclone chamber and a second end in fluid communication with an outlet of the dustcatcher. In embodiments comprising an exit pipe, the second end of such a bypass pipe is preferably in fluid communication with a portion of the exit pipe external to the cyclone chamber. Such a bypass pipe allows gas flow containing small size particles such as those containing zinc to flow directly from the cyclone chamber to the exit pipe such that the zinc-containing particles are not filtered out. In this manner the efficiency of the cyclonic adaptor is selectively “de-rated” or tuned in order that zinc-containing particles are transferred to downstream (secondary) gas cleaning apparatus rather than being filtered out in the preliminary gas cleaning stage.

Advantageously the at least one bypass pipe may comprise a valve operable to selectively control the gas flow impedance of the bypass pipe. In other words the valves are movable between a fully sealed position and a fully open position in incremental stages such that the bypass pipe may be partially obscured. This allows fine-control of the efficiency of the cyclonic adaptor, and it is envisaged that the cyclonic adaptor may comprises a plurality of such bypass pipes each containing a valve that can be selectively actuated. The valves may be pneumatically actuated either by a power source or by manual operation.

The at least one input pipe may comprise a valve operable to selectively control the gas flow impedance of the at least one input pipe. This allows the cyclonic adaptor to be isolated from the remainder of the metallurgical processing plant through actuation of the valve, for example for maintenance purposes.

The at least one input pipe has a first end in fluid communication with an inlet of the dustcatcher and adapted to receive exhaust gas from the inlet of the dustcatcher. In one embodiment, the first end of the at least one input pipe is attachable to the inlet of the dustcatcher. This allows for particularly straightforward installation, especially where the at least one input pipe is adapted to be housed within the internal volume of the pre-existing dustcatcher, and exhaust gas flows directly from the inlet of the dustcatcher into the at least one input pipe.

The at least one input pipe may be attachable to the inlet of the dustcatcher and comprise a portion that is external to the dustcatcher. In such an arrangement the at least one input pipe extends from the inlet, through an external wall of the dustcatcher, and back through the external wall such that the second end of the input pipe is in fluid communication with the interior of the cyclone chamber.

In other embodiments, the cyclonic adapter further comprises a sealing member adapted to be positioned within the dustcatcher so as to define a chamber within the dustcatcher into which the exhaust gas from the inlet is received in use, and wherein the first end of the at least one input pipe is in fluid communication with said chamber. Such a sealing member is typically adapted to extend across an interior cross-sectional area of the dustcatcher in order to define the chamber.

In one such embodiment, the first end of the at least one input pipe is attachable to an external wall of the dustcatcher. In such an arrangement, exhaust gas flows from the inlet into the chamber within the interior volume of the dustcatcher, and into the at least one input pipe. Such an input pipe is primarily external to the dustcatcher, and has a geometry such that it extends back into the dustcatcher such that the second end of the input pipe is in fluid communication with the interior of the cyclone chamber.

In one embodiment, the sealing member comprises an orifice in fluid communication with the first end of the at least one input pipe such that the exhaust gas flows from the chamber into the cyclone chamber. Typically the first end of the at least one input pipe is attachable to the sealing member.

In arrangements using a sealing member, the cyclonic adapter preferably further comprises a distribution member adapted to be positioned within the dustcatcher and having a geometry adapted to direct the exhaust gas to the at least one input pipe. The distribution member is typically substantially conical. The sealing plate and distribution member may be formed as a unitary member or provided as separate parts.

The at least one input pipe, the cyclone chamber and the exit pipe (where used) may be provided as separate parts. The provision of separate parts in this way allows for modular construction of the cyclonic adaptor, which may advantageously allow for ease of installation, especially in environments where access to the pre-existing dustcatcher is space-constrained.

In accordance with a second aspect of the present invention there is provided a method for removing solid particles from a metallurgical processing plant exhaust gas, the method comprising: providing a cyclonic adaptor for fitting to a gravity-based dustcatcher for a metallurgical processing plant, the cyclonic adaptor comprising; a cyclone chamber having a curved inner surface for guiding a gas flow within the interior of the cyclone chamber in a cyclonic manner, the cyclone chamber comprising an exit in fluid communication with an outlet of the dustcatcher in use, and; at least one input pipe having a first end and a second end, the second end being in fluid communication with the interior of the cyclone chamber and arranged to direct exhaust gas in an at least primarily tangential direction with respect to the curved inner surface of the cyclone chamber, the method further comprising; coupling the first end of the input pipe such that it is in fluid communication with an inlet of the dustcatcher and such that the cyclone chamber is housed within an interior volume of the dustcatcher and further such that; exhaust gas containing solid particles from the metallurgical processing plant flowing from the inlet of the dustcatcher enters the cyclone chamber and flows in a cyclonic manner in order to remove solid particles from the exhaust gas before flowing through the exit to the outlet of the dustcatcher.

Preferably the cyclonic adapter further comprises an exit pipe having a first end positioned in fluid communication with the interior of the cyclone chamber and a second end in fluid communication with the outlet of the dustcatcher in use, and the exit pipe forms said exit, and wherein the method further comprises; coupling the second end of the exit pipe to an outlet of the dustcatcher.

The method may further comprise the steps of providing at least one bypass pipe having a first end in fluid communication with the cyclone chamber and a second end in fluid communication with a portion of the exit pipe external to the cyclone chamber, the at least one bypass pipe comprising a valve operable to selectively control the gas flow impedance of the bypass pipe, and; selectively actuating the valve of the at least one bypass pipe in order to control the size of solid particles removed from the exhaust gas. As described above in relation to the first aspect of the invention, selectively actuating the valve of the at least one bypass pipe allows the efficiency of the cyclonic adaptor to be tuned.

In embodiments where an exit pipe is not used, the second end of such a bypass is in fluid communication with an outlet of the dustcatcher.

The selectively actuating the valve may be carried out based on data collected from the dustcatcher relating to the size of the solid particles being removed from the exhaust gas.

As described above in relation to the first aspect, the cyclonic adaptor may be provide as an integral unit or alternatively may be provided as separate parts. In the latter case, at least one of the cyclone chamber, the at least one input pipe and the exit pipe (where used) are provided as separate parts, and the method further comprises the step of coupling at least one of the exit pipe (where used) and the at least one input pipe to the cyclone chamber in order to form the cyclonic adaptor.

In accordance with a third aspect of the invention there is provided a modified gravity-based dustcatcher for a metallurgical processing plant, the dustcatcher having an interior volume within which is located the cyclone chamber of a cyclonic adaptor according to the first aspect of the invention, wherein the at least one input pipe of the cyclonic adaptor has a first end in fluid communication with an inlet of a dustcatcher. In embodiments where the cyclonic adapter comprises an exit pipe, the second end of the exit pipe is preferably coupled to an outlet of the dustcatcher.

In a fourth embodiment there is provided a cyclonic adaptor for fitting to a gravity-based dustcatcher for a metallurgical processing plant, comprising: at least one input pipe attachable to an inlet of a dustcatcher; a cyclone chamber having a curved inner surface for guiding a gas flow within the interior of the cyclone chamber in a cyclonic manner, and; an exit pipe having a first end positioned in fluid communication with the interior of the cyclone chamber and a second end attachable to an outlet of the dustcatcher, wherein; the input pipe has a first end adapted to receive exhaust gas containing solid particles from a metallurgical processing plant through the inlet of the dustcatcher and extends from said first end to a second end positioned in fluid communication with the interior of the cyclone chamber, wherein; the second end is arranged to direct the exhaust gas in an at least primarily tangential direction with respect to the curved inner surface of the cyclone chamber such that the exhaust gas entering the cyclone chamber flows in a cyclonic manner in order to remove solid particles from the exhaust gas before flowing through the exit pipe, and wherein; the cyclone chamber is adapted to be housed within an interior volume of the dustcatcher.

In a fifth embodiment there is provided a cyclonic adaptor for fitting to a gravity-based dustcatcher for a metallurgical processing plant, comprising: at least one input pipe, and; a cyclone chamber having a curved inner surface for guiding a gas flow within the interior of the cyclone chamber in a cyclonic manner, the cyclone chamber comprising an exit in fluid communication with an outlet of the dustcatcher in use, wherein; the at least one input pipe has a first end in fluid communication with an inlet of the dustcatcher in use and adapted to receive exhaust gas containing solid particles from a metallurgical processing plant from the inlet of the dustcatcher, and extends from said first end to a second end positioned in fluid communication with the interior of the cyclone chamber, wherein; the second end is arranged to direct the exhaust gas in an at least primarily tangential direction with respect to the curved inner surface of the cyclone chamber such that the exhaust gas entering the cyclone chamber flows in a cyclonic manner in order to remove solid particles from the exhaust gas before flowing through the exit, and wherein the cyclone chamber is adapted to be housed within an interior volume of the dustcatcher, and further wherein; the at least one input pipe is not attachable to the inlet of the dustcatcher, and the exit does not comprise an exit pipe having a first end positioned in fluid communication with the interior of the cyclone chamber and a second end attachable to an outlet of the dustcatcher.

### BRIEF DESCRIPTION OF THE DRAWINGS

The invention will now be described with reference to the following drawings, in which:

FIG. 1 is a schematic illustration of a metallurgical furnace plant as is known in the art;

FIG. 2 is a diagram of a gravity-based dustcatcher as is known in the art;

FIG. 3 shows a cyclonic adaptor according to a first embodiment of the invention;

FIG. 4 is a cut-away illustration of the top part of a cyclonic adaptor according to the first embodiment of the invention fitted to a conventional dustcatcher;

FIG. 5A shows a cyclonic adaptor according to a first embodiment of the invention fitted to a conventional dustcatcher;

FIG. 5B shows a cyclonic adapter according to a second embodiment of the invention, fitted to a conventional dustcatcher;

FIG. 6 shows a cyclonic adaptor according to the first embodiment of the invention;

FIG. 7 shows a cyclonic adapter according to a third embodiment of the invention, fitted to a conventional dustcatcher;

FIG. 8 shows a cyclonic adapter according to a fourth embodiment of the invention, fitted to a conventional dustcatcher;

FIG. 9 illustrates a magnified view of the underside of a cyclone chamber of a cyclonic adapter according to the invention;

FIG. 10 is a flow diagram of a method of fitting a cyclonic adapter of the first or second embodiments to an existing dustcatcher;

FIG. 11 is a flow diagram of method of fitting a cyclonic adaptor of the third of fourth embodiments to an existing dustcatcher, and;

FIG. 12 is a plan view showing a sealing member.

### DETAILED DESCRIPTION

For ease of description, the cyclonic adapter in the drawings and in the following description have each been illustrated as comprising an exit pipe. However, in other embodiments as has been outlined above, the cyclonic adapter may not comprise an exit pipe and instead the cyclone chamber may comprise an exit in fluid communication with an outlet of the dustcatcher.

The following description describes a preferred embodiment of the invention being used to treat off-gas in a gas cleaning system for an iron-producing blast furnace plant. However, the invention may be used in any metallurgical processing plant environment.

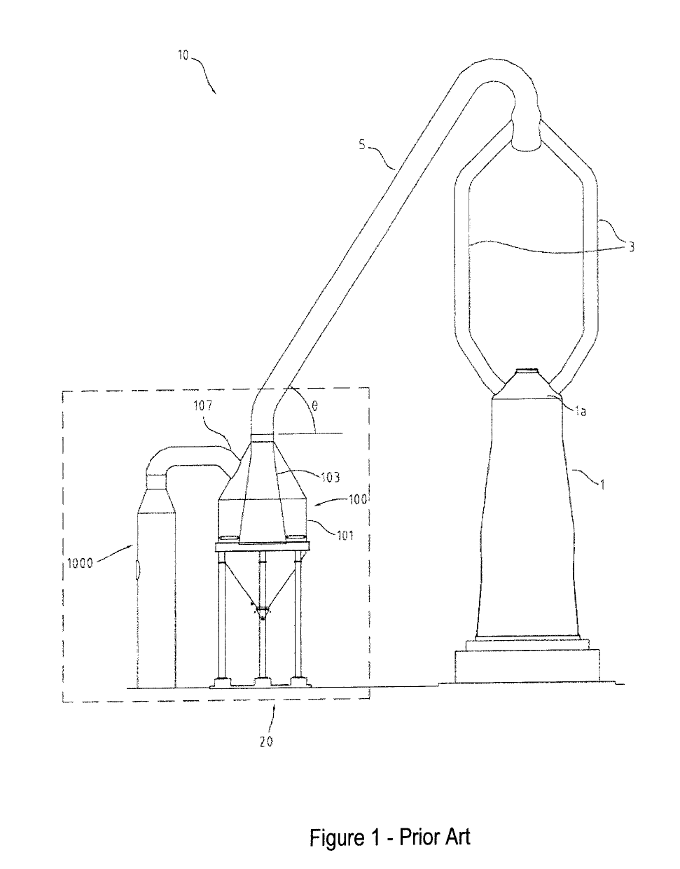

FIG. 1 is a schematic illustration of a blast furnace plant 10. The plant 10 comprises a blast furnace 1 in which iron ore is produced as is known in the art. A top part 1a of the blast furnace 1 is coupled to an off-gas system shown generally at 3. Off-gas produced by the blast furnace process flows through the off-gas system 3 and into downcomer 5. The downcomer is generally directed at an angle θ with respect to the horizontal, typically between 40° and 55°.

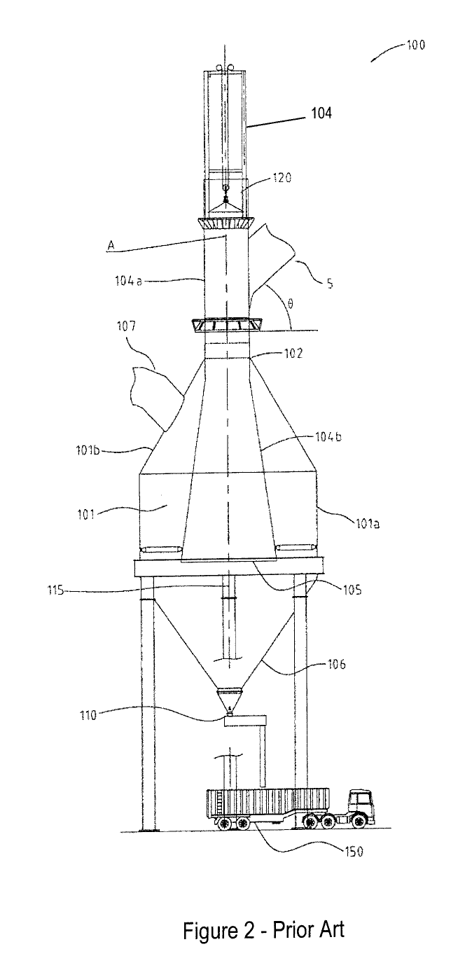

The downcomer 5 introduces the off-gas to gas cleaning system shown generally at 20. More specifically, the downcomer 5 is coupled to a gravity-based dustcatcher 100 which acts as a preliminary cleaning stage of the gas cleaning system 20, and will be described in further detail with reference to FIG. 2. Dust particles from the off-gas are removed within the dustcatcher and the off-gas exits the dustcatcher through exit 107 and flows into wet scrubber 1000 (which could alternatively be an electrostatic precipitator or dry type filter) for further treatment.

FIG. 2 illustrates a conventional gravity-based dustcatcher 100 as is known in the art. The dustcatcher 100 comprises a hollow separation chamber 101 having a substantially cylindrical main part 101a and a top part 101b having a frusto-conical geometry such that a circular opening 102 is defined in an upper region of the top part 101b, through which extends a vertically oriented inlet pipe 104. The cylindrical main part 101a has a central main axis 115, and the top part 101b, circular opening 102 and inlet pipe 104 feeding the dustcatcher are all co-axial with respect to the central main axis 115.

The inlet pipe 104 has a cylindrical part 104a external to the separation chamber 101 that extends upwards from the circular opening 102 to an optional isolation valve 120. The inlet pipe 104 also comprises a trumpet section 104b that extends downwards from the opening 102 into the separation chamber or frusto-conical sections 101 and diverges outwards in a frusto-conical manner such that a circumference of opening 105 of the inlet pipe positioned within the main part 101a of the separation chamber 101 is greater than the circumference of opening 102.

The downcomer 5 is coupled to the external cylindrical part 104a of inlet pipe 104 such that off-gas flows through the downcomer 5 into the inlet pipe 104, through the trumpet section 104b and into the separation chamber 101 through inlet pipe opening 105.

A collection hopper 106 having a funnel shape with its widest diameter uppermost is coupled to a lower end of the separation chamber 101. A closable dust discharge port 110 is provided at the bottom of the collection hopper. The collection hopper 106 and dust discharge port 110 are centered about central main axis 115.

An outlet gas pipe 107 is positioned in a side wall of the top part 101b of the separation chamber 101.

In use, off-gas from the blast furnace containing dust particles flows along the downcomer 5 and into the separation chamber 101 via the inlet pipe 104. Therefore the off-gas is introduced axially with respect to the separation chamber 101. As can be seen from FIG. 2, the diameter of the main part 101a separation chamber 101 is much greater than that of the inlet pipe 104 and inlet pipe opening 105. Therefore, the off-gas undergoes a substantial decrease in velocity upon flowing from the inlet pipe 104 into the separation chamber 101. Furthermore, as the outlet gas pipe 107 is positioned in the top part 101b of the separation chamber 101, the off-gas flow is forced to reverse its direction of flow at the bottom of the separation chamber such that it can flow out of the dustcatcher through the outlet pipe 107. The reduction in velocity and the change of direction of flow causes the dust particles to be separated from the off-gas due to gravity and are collected in the collection hopper 106.

At regular intervals, or when the collection hopper 106 is full, the dust discharge port 110 is opened and the collected dust falls under gravity into a secondary container 150, typically a goods wagon. In many cases the collected dust can be recycled back into the blast furnace.

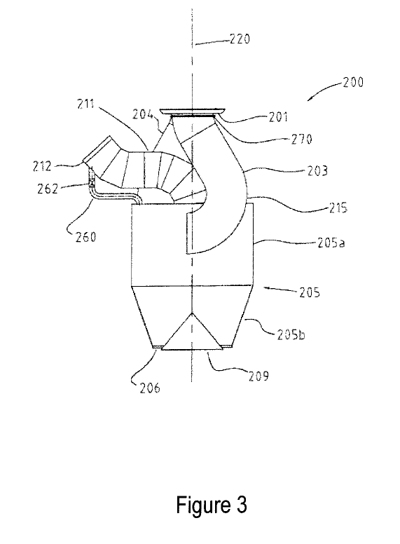

A cyclonic adaptor 200 according to a first embodiment of the invention is shown in FIG. 3. The cyclonic adaptor 200 is designed to be installed within an existing dustcatcher such as the dustcatcher 100 described above. The ability to “retro-fit” the cyclonic adaptor 200 to the dustcatcher changes the mode of operation of the dustcatcher from being gravity-based to being cyclone-based with minimal installation disruption to the blast furnace plant. A cyclonic adaptor 200 according to a first embodiment will now be described.

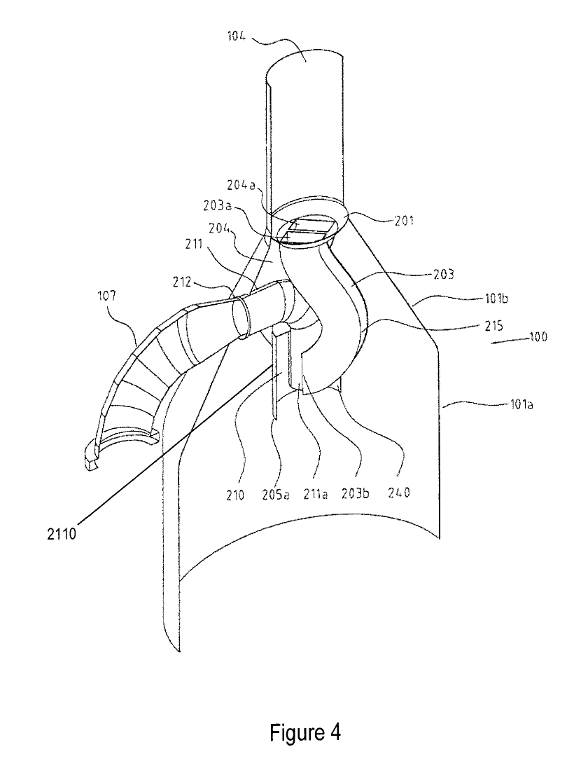

The cyclonic adaptor 200 comprises an attachment member 201 at an upper end of the unit for attachment to the inlet pipe 104 of a conventional gravity-based dustcatcher. As clearly seen in FIG. 4, attachment member 201 has a substantially circular geometry and has a diameter that matches that of the inlet pipe 104 such that when fitted, the attachment member substantially seals inlet pipe 104 apart from two spaced apart rectangular inlet openings 203a and 204a of first and second input pipes 203 and 204 respectively. In other words, when the attachment member 201 is fitted, off-gas flowing through the input pipe 104 of the dustcatcher 100 is directed into the first and second input pipes 203, 204 by means of the attachment member 201.

Typically, the attachment is achieved using a weld. Thus, the attachment member 201 can be fitted inside of the inlet 104 and connected with a fillet weld, or attached as a butt weld to the inlet pipe 104 in a similar way to the original trumpet that it replaces (shown at 103 in FIG. 1).

When fitting the cyclonic adaptor 200 to the inlet pipe 104, the trumpet section 104b is preferably removed such that the attachment member 201 is coupled to the cylindrical part 104a of the inlet pipe 104. In this case the diameter of the attachment member 201 is the same as that of the cylindrical part 104a of the inlet pipe 104. However, it is envisaged that in some scenarios, the cyclonic adaptor 200 may be attached to the trumpet section 104b in which case the diameter of the attachment member would match that of the opening 105.

First and second input pipes 203, 204 extend from their inlet openings 203a, 204a to exit openings within a hollow cyclone chamber 205. Cyclone chamber 205 comprises a substantially cylindrical part 205a within which the exit openings of the first and second input pipes are located and in fluid communication. The exit opening 203b of first input pipe 203 is seen in FIG. 4 (the exit opening of second input pipe is obscured). As seen in FIG. 3, cyclone chamber 205 further comprises a funnel-shaped part 205b attached to the lower end of, and co-axial with, the cylindrical part 205a. The diameter of the cyclone chamber gradually decreases along the length of the funnel-shaped part to define an opening 206 at the lower end of funnel-shaped part 205b. The cyclone chamber is sealed at a top end proximal the attachment member 201. The wall of the cyclone chamber 205 has a curved inner surface shown at 240 in FIG. 4. The exit openings of the input pipes are flush with the inner surface 240 so as not to impede the cyclonic flow of gas within the cyclone chamber 205.

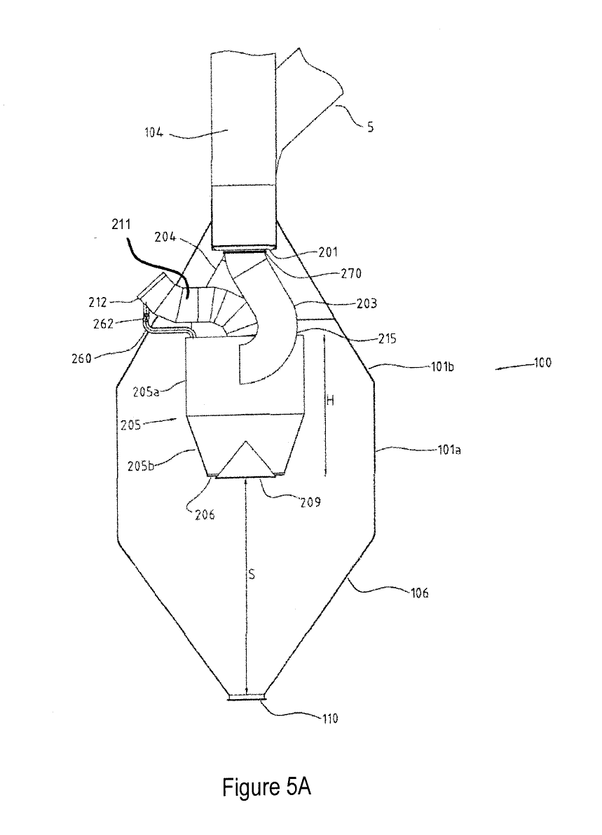

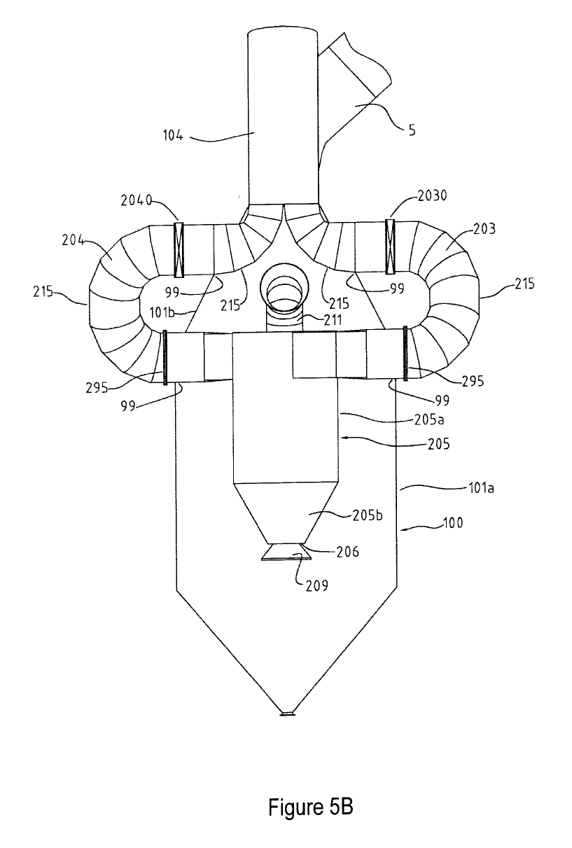

In FIG. 5, a cyclone shedder 209 having the form of a cone is positioned centrally within the circular opening 206 and is supported (supports not shown) so as to define an annular shaped opening 206 at the bottom of the funnel-shaped part between the side walls of the funnel-shaped part 205b and the cyclone shedder 209. The cyclone shedder will be described in more detail below.

The diameter of the cylindrical part 205a of the cyclone chamber is chosen based on the specifications of the dustcatcher in which it is to be fitted, but it is typically around 4-5 m. The diameter of a typical gravity based dustcatcher is in the range of 8-15 m.

The cyclone chamber 205, attachment member 201 and cyclone shedder 209 are co-axial about a main axis 220 of the cyclone chamber 205.

FIG. 4 is a cut-away illustration of a top portion of the cyclonic adaptor 200 when fitted within a conventional gravity-based dustcatcher 100. As seen in FIG. 4, the cyclonic adaptor 200 further comprises an exit pipe 211 that is coupled to existing outlet pipe 107 of the dustcatcher. The exit pipe 211 of the cyclonic adaptor 200 is attached to the outlet pipe by coupling member 212. The coupling member 212 may include a tapering section so as to smoothly transition between the bore diameter of the exit pipe 211 and the (typically larger) bore diameter of the existing outlet pipe 107. A first portion 2110 of the exit pipe having first end 211a is housed within the cyclone chamber 205 and is cylindrical and substantially co-axial with the cyclone chamber 205 so as to define an annular region 210 between the outer surface of the first portion 2110 of the exit pipe and the inner surface 240 of the cyclone chamber 205. The exit pipe extends from its first end 211a within the cyclone chamber 205 through the top of the cyclone chamber to the coupling member 212 where a second end of the exit pipe is attached to the outlet pipe 107 of the dustcatcher by coupling member 212.

In the described embodiment the exit pipe 211 extends through the outer wall of the dustcatcher 100 and is attached to outlet pipe 107 externally to the interior volume of the dustcatcher (see FIG. 5). However, it is to be appreciated that the exit pipe 211 may be coupled to the outlet pipe 107 within an interior volume of the dustcatcher. In practice, exit pipe 211 may be coupled to the outlet pipe 107 within an interior volume of the dustcatcher if the outlet pipe exists in the interior volume of the dustcatcher and this can be physically achieved. Generally the existing outlet of the dustcatcher will be through the upper conical section of the dustcatcher as shown in FIGS. 4 and 5. The actual detail of the connection and the likelihood of changing duct diameters will be done on an as-by-case basis as each dustcatcher will be different.

The exit pipe 211 typically has a diameter in the range of 1 m to 2 m.

The exit pipe 211 extends downwards within the cyclone chamber 205 such that its first end 211 is positioned below the exit openings of the first and second input pipes such that gas flowing into the cyclone chamber through the first and second input pipes does not flow directly into the exit pipe 211.

In alternative embodiments the exit pipe 211 is not present and the cyclone chamber 205 comprises an exit orifice in the top part of the cyclone chamber (e.g. where the exit pipe 211 meets the cyclone chamber in the view of FIG. 5). Such an exit orifice allows gas from the cyclone chamber that has been removed of solid particles to flow from the cyclone chamber to the outlet of the dustcatcher.

First and second input pipes have a curved section (shown generally at 215) as shown in in FIGS. 3 to 5 such that off-gas flowing into respective inlet openings 203a, 204a in an axial direction with respect to the cyclone chamber 205 is redirected and exits the inlet pipes 203, 204 in a direction that is primarily tangential to the inner surface 240 of cylindrical part 205a of cyclone chamber 205. In other words, the off-gas enters the cylindrical part 205a of the cyclone chamber with a direction vector that, when defined in terms of tangential and radial components, is primarily comprised of the tangential component, and when defined in terms of horizontal and vertical components, is primarily comprised of the horizontal component (i.e. in a plane perpendicular to the main axis 220 of the cyclone chamber).

The exit openings of first and second input pipes 203, 204 are positioned adjacent the inner surface 240 of the cyclone chamber 205 (i.e. at a radial positions substantially equal to the radius of the cyclone chamber). This ensures that the off-gas entering the cyclone chamber 205 is as close as possible to the inner surface 240 of the cyclone chamber 205 for maximum angular momentum generation in order to generate a cyclonic flow within the cyclone chamber. The inlet velocity of the gas is typically greater than 15 m/s, with an outlet velocity of typically less than 25 m/s.

In a preferred embodiment, the exit openings of the input pipes are angled downwards slightly with respect to the horizontal, more specifically angled downwards with respect to a plane having a normal parallel to the main axis 220 of the cyclone chamber, in order to assist in generating a cyclonic flow that flows downwards under gravity through the cyclone chamber towards funnel-shaped part 205b. However, as discussed above, even when the exit openings of the input pipes are angled slightly, the off-gas still enters the cyclone chamber 205 with a direction vector that is primarily tangential and, when defined in terms of horizontal and vertical components, is primarily comprised of the horizontal component.

As discussed above, the inlet openings 203a, 204a of the input pipes 203, 204 have a rectangular cross-section. This rectangular cross-sectional geometry is maintained along the length of the input pipes 203, 204 such that the output openings also have rectangular geometry. As seen in FIG. 4, the exit opening 203b of input pipe 203 has rectangular geometry with the long edge of the exit opening directed along the main axis 220 of the cyclone chamber 205. This is beneficial in various ways. Firstly, having such a “long” aspect ratio along the length of the cyclone chamber 205 means that as much off-gas entering the cyclone chamber 205 is positioned as close to the inner surface 240 of the cyclone chamber 205 as possible, increasing the angular momentum of the gas flow and allowing for efficient cyclone generation. A second benefit is that the rectangular geometry aids in a filtering of particle size within the gas flow that will be explained below.

Although the cross-sectional geometry of the input pipes of the presently described embodiment is rectangular, it will be appreciated by the skilled person that other input pipe cross-sectional geometries may be used.

The exit openings of the first 203 and second 204 input pipes are directed in substantially opposing directions, and laterally spaced by a distance substantially equal to the diameter of the cyclone chamber 205. This arrangement aids in creating an efficient cyclonic gas flow within the cyclone chamber. It will be appreciated however that other input pipe arrangements could be used, such as a single pipe or three or more input pipes.

FIG. 5A shows the cyclonic adaptor 200 installed within a conventional dustcatcher. As has been described, a particular benefit of the present invention is that the cyclonic adaptor can be retro-fitted to an existing dustcatcher, thereby vastly increasing the efficiency of the dustcatcher without having to build a specific new unit. As explained above, in this embodiment the attachment member 201 attaches to the input pipe 104 (the trumpet part 104b having being removed), and the exit pipe 211 couples to the existing outlet pipe 107 of the dustcatcher. The cyclone chamber 205 is supported by the coupling between coupling member 201 and inlet pipe 104 and is suspended in free space within the separation chamber 101 of the dustcatcher.

In operation, off-gas from the blast furnace comprising particulate matter flows along downcomer 5 and inlet pipe 104 as with the conventional gravity-based dustcatcher. Upon meeting attachment member 201, the gas flow is split into two streams with one stream flowing through input pipe 203 and one stream flowing through input pipe 204. Due to the diverting of the gas from flowing in an axial direction to a primarily tangential direction with respect to the cyclone chamber 205, a cyclonic flow is generated within the cyclone chamber.

Assisted by gravity and the downward tilt of the exit openings described above, the cyclonic flow travels downwards through the cyclone chamber 205 towards the funnel shaped part 205b. During this time, centrifugal forces acting on the dust particles within the gas flow force the particles radially outwards towards the inner surface 240 of the cyclone chamber 205. Once the particles hit the inner surface, they lose their momentum and slide down the inner surface of the cyclone chamber 205, through the annular opening 206 and into the existing collection hopper 106 of the dustcatcher under gravity. The collected dust in the collection hopper 106 is stored and processed in the same manner as for a conventional gravity-based dustcatcher.

The cyclonic gas flow travelling downwards through the cyclone chamber is re-directed upwards by cyclone shedder 209 and travels upwards through the center of the cyclone chamber 205, through first end 211a of exit pipe 211 and out of the existing outlet 107 of the dustcatcher. The gas flow travelling upwards through the exit pipe is “clean” in that it contains substantially fewer dust particles than the gas flow entering the cyclonic adaptor.

The length H of the cyclone chamber 205 (and therefore the extent to which the cyclonic adaptor extends within the dustcatcher as shown in FIG. 5) can be tuned through the use of the cyclone shedder 209. It will be appreciated that a cyclonic gas flow will be reflected back upon itself if it travels along a funnel-shaped section with ever-decreasing diameter. Therefore, the funnel-shaped portion 205b of the cyclone chamber 205 could be used to reflect the cyclonic flow back towards the exit pipe 211 (i.e. rather than cyclone shedder 209). However, such a funnel-shaped portion would have to have a large length in order to satisfactorily reflect the cyclonic flow, thus increasing the overall length H of the cyclone chamber 205. Increasing the overall length of the cyclone chamber 205 would decrease the amount of storage space (depicted at S in FIG. 5) available in the collection hopper 106. Reducing the amount of storage space increases the frequency of discharge batch operations required and reduces the time available for maintenance of the dust discharging system. Therefore, by using the cyclone shedder 209 to reflect the cyclonic flow, the length H of the cyclone chamber 205 is reduced, thereby maximising the storage capacity of the collection hopper 106. This enables continuous operation of the cyclone system for a number of hours whilst allowing for maintenance of the dust discharging system.

In the presently described embodiment, the cyclone shedder 209 is supported within the lower opening 206 of the cyclone chamber. However, the cyclone shedder may alternatively be supported within the collection hopper 106 of the pre-existing dustcatcher.

The exact size and geometry of the cyclone shedder and tapering of the funnel-shaped part 205b (and therefore the length of the cyclone chamber) can be varied according to the specifications of the dustcatcher in which the cyclonic adaptor is being fitted, and the requirements of the associated blast furnace plant.

Although the cyclone chamber 205 has been described above as having a substantially cylindrical part 205a and a funnel-shaped part 205b, it will be appreciated that the cyclone chamber 205 could have alternative geometries. For example the cyclone chamber could comprise a continuous funnel-shaped member with a continuously-decreasing circumference along its length. The cyclone chamber may alternatively comprise a top part having a frusto-conical geometry coupled to a funnel-shaped part as described above.

FIG. 5B illustrates a second embodiment similar to that shown in FIG. 5A but where the cyclonic adapter comprises first 203 and second 204 input pipes each having at least a portion external to the pre-existing dustcatcher 100. The first and second input pipes are attached to the inlet pipe 104 via attachment member 201 (not shown) as before, and extend from the inlet pipe 104 to the cyclone chamber 205. Both input pipes have curved sections, shown generally at 215, such that the off-gas flowing into the input pipes 203, 204 in a primarily axial direction with respect to the cyclone chamber 205 is redirected and exits the input pipes 203, 204 in a direction that is primarily tangential to the inner surface of cylindrical part 205a of the cyclone chamber 205.

Openings shown generally at 99 are formed in the outer walls of the existing dustcatcher such that the input pipes can be formed so as to have at least a portion external to the dustcatcher. In FIG. 5B the input pipes are shown extending through the main part 101a and top part 101b of the separation chamber 101 of the dustcatcher 100. However it will be appreciated that the input pipes may extend through different portions of the dustcatcher according to the particular arrangement of the dustcatcher.

The input pipes 203, 204 may comprise isolation valves, shown generally at 2030, 2040 positioned on the portions of the pipes external to the dustcatcher. The external positioning of these isolation valves allows for ease of access and maintenance of the pipes. Such an isolation valve may be a slide-type valve to variably control the degree of isolation of the dustcatcher but other types of valve are envisaged.

Cyclonic dust removal has a much greater efficiency than that of a conventional gravity-based dustcatcher, and efficiencies of up to 100% can be achieved with cyclone technology. As discussed above, the dust that is collected in a conventional gravity-based dustcatcher can be recycled back into the blast-furnace. Unfortunately however, zinc (which is undesirable to be recycled back into the blast furnace process) is prevalent on dust particles smaller than 20 μm in diameter which are now able to be filtered out within the dustcatcher due to the cyclonic adaptor 200. It is desired that the zinc-containing particles are instead passed on to the downstream (secondary cleaning) apparatus in the gas cleaning system rather than being filtered out within the dustcatcher.

It is therefore desired to “de-rate” the efficiency of the cyclonic adaptor 200 in order that it does not filter out the dust particles containing zinc and these can instead flow through the exit pipe 211 to the downstream apparatus of the gas cleaning system. FIGS. 3, 5A and 5B all illustrate a bypass pipe 260 extending from the upper part of the cyclone chamber 205 directly to exit pipe 211 (external to the cyclone chamber) which allows the efficiency of the cyclonic adaptor 200 to be selectively reduced (typically to 70-85%). The bypass pipe 260 is positioned above the exit openings of the input pipes.

As the off-gas flowing through the input pipes 203, 204 travels around the curved section 215, larger particles suspended in the gas flow tend to move to the bottom of the input pipe, whereas the smaller particles are affected less by the bends and remain more evenly distributed in the flow. A proportion of smaller particles near the top of the input pipe are directed into the bypass pipe 260 rather than entering the cyclonic flow within the cyclone chamber 205, and in this way the cyclonic adaptor 200 is selectively de-rated such that fewer particles containing zinc are filtered out into the collection hopper 106. The vertically-orientated rectangular cross-sections of the exit openings of the input pipes described above aids in this guiding of the smaller particles less affected by the bends directly into the bypass pipe 260.

Although only one bypass pipe 260 is illustrated in FIGS. 3, 5A and 5B, it will be appreciated that a plurality of bypass pipes may be positioned around the circumference of the cyclone chamber 205 depending on the requirements of the dust filtering. Furthermore, each bypass pipe 260 may comprise a valve 262 such that the efficiency of the dust filtering can be tuned as desired by opening and closing the valves. The valves may be able to be opened or closed by varying amounts in order to fine-tune the efficiency of the dust filtering. The valves are typically pneumatically-actuated rubber pinch-type valves, which are controlled externally to the dustcatcher, for example by an operator or by control software. However, other types of valve are envisaged.

Bypass pipe(s) may be fitted to each of the embodiments described herein.

As illustrated in FIGS. 3, 5A and 5B, the cyclonic adaptor 200 may further comprise an isolation valve 270 positioned at a top portion of the input pipes or integrated with the attachment member 201. The isolation valve allows the dustcatcher to be isolated from the remainder of the blast furnace plant, for example for maintenance purposes. Such an isolation valve may be a slide-type valve to variably control the degree of isolation of the dustcatcher but other types of valve are envisaged.

Preferably, the interior of the input pipes 203, 204 and the attachment member 201 are lined with a wear resistant lining such as alumina ceramic (or zirconium corundum as another example), or may be lined with metallic/non-metallic wear resistant plates. This is particularly beneficial at the bend portions 215 of the pipes where larger particles within the gas flow are forced to the interior walls of the pipes. Similarly, the cyclone chamber could be lined with wear resisting materials, with the possibility to line different sections with different types of materials, dependent on the degree of the wear which can occur in the different areas.

As has been described above, the first 203 and second 204 input pipes have curved sections 215 such that off-gas flowing into respective inlet openings 203a, 204a in an axial direction with respect to the cyclone chamber 205 is redirected and exits the inlet pipes in a direction that is primarily tangential to the inner surface 240 of cylindrical part of cyclone chamber 205. Furthermore, the exit pipe 211 has a first portion 2110 positioned within and coaxial with the cyclone chamber 205, and is shaped to change the direction of gas flow in order to cooperate with the outlet of the existing dustcatcher. In general, the cyclonic adapter 200 is designed such that the input pipe(s) re-direct the off-gas that would flow into the pre-existing dustcatcher (typically substantially axially with respect to the dustcatcher) such that the gas enters the cyclone chamber in a primarily tangential direction, and the exit pipe re-directs the gas entering the exit pipe to a direction corresponding to the pre-existing outlet of the pre-existing dustcatcher.

In the embodiments shown so far, the first and second input pipe(s) each have a first end attachable to the inlet pipe 104. However, in other embodiments, the input pipes are not directly attachable to the input pipe 104, as will be explained below. However, the input pipes are still in fluid communication with the input pipe.

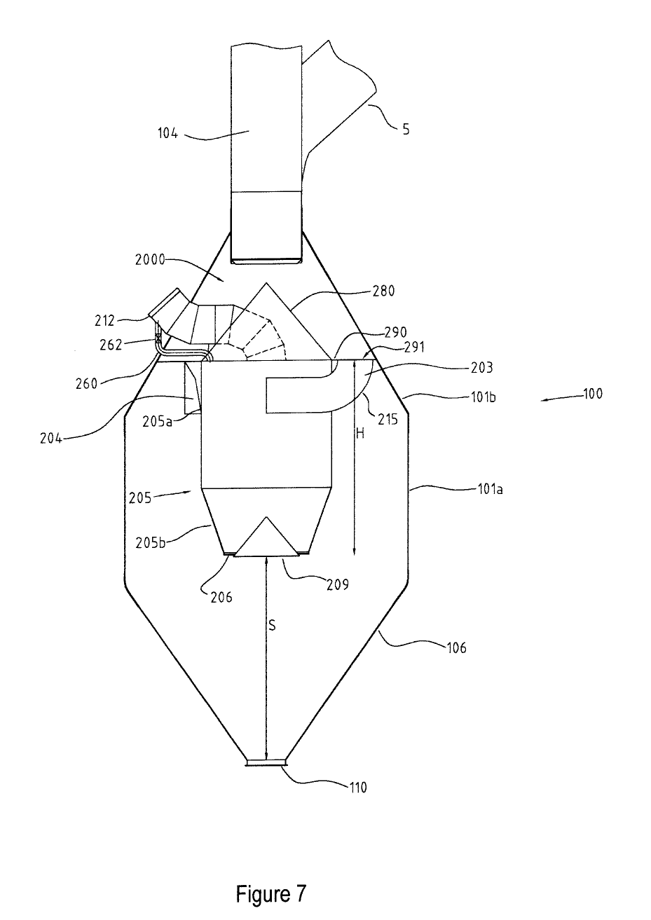

FIG. 7 illustrates a third embodiment of the cyclonic adapter where the input pipes 203, 204 are not attachable to, and therefore do not extend from, the inlet pipe 104, but instead off-gas flows directly into the top part 101b of the separation chamber. Here the cyclonic adapter further comprises a sealing member 290, typically in the form of a plate extending across the interior cross section of the housing 101 so as to isolate the interior volume of the housing below the isolation member from the off-gas. In this manner, an interior chamber (shown generally at 2000) is defined within the dustcatcher 100 and in fluid communication with the inlet 104.

The cyclone chamber 205 is supported by a support structure (not shown).

The sealing member 290 comprises at least one orifice 291 associated with each input pipe 203, 204 such that off-gas from the inlet pipe 104 is able to flow from the chamber 2000 into the cyclone chamber 205 through input pipes 203, 204. The at least one orifice is substantially aligned with the inlet opening of the respective input pipe. In the arrangement of FIG. 7, three input pipes are present.

The cyclonic adapter may further comprise a distribution member 280 within chamber 2000. The distribution member is shaped so as to direct off-gas from the inlet pipe 104 into the input pipes 203, 204 through the respective orifices in the sealing member. The distribution member 280 is typically conical is shape, although other geometries adapted to divert the flow of off-gas are envisaged, such as pyramid geometries. The sealing member 290 and distribution member 280 may be formed as a unitary member or may be separate parts. The distribution member 280 is typically positioned substantially coaxially with the at inlet pipe 204, although it may be positioned so as to direct the off-gas in the most efficient manner.

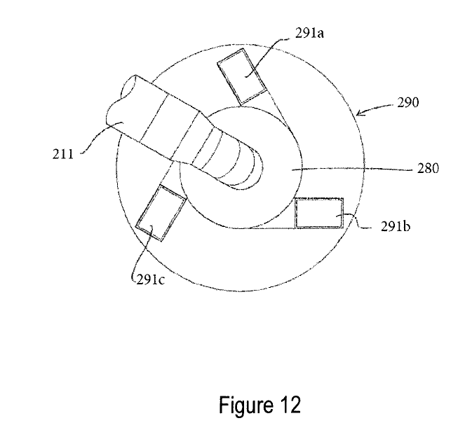

FIG. 12 illustrates a plan view of the sealing member 290 which clearly illustrates the orifices associated with the input pipes. In the example of FIG. 12 there are three orifices 291a, 291b and 291c associated with three respective input pipes. The distribution member 280 and exit pipe 211 are also shown.

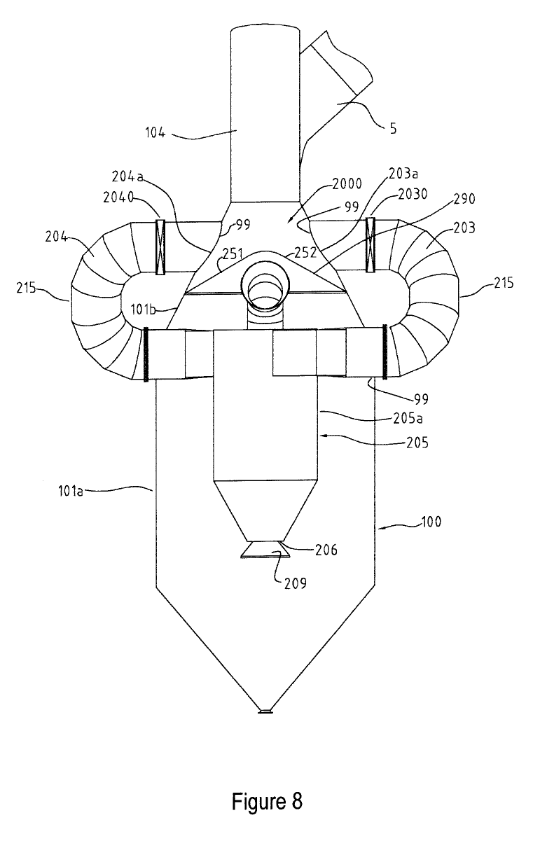

FIG. 8 illustrates a fourth embodiment of a cyclonic adapter. In this embodiment, instead of the input pipes being attachable to the inlet pipe 104, the input pipes 203, 204 are attached to openings (shown at 99) made in the top part 101b of the separation chamber of the dustcatcher. Here, the cyclonic adapter further comprises a sealing member 290 positioned within the separation chamber of the pre-existing dustcatcher and below the inlet openings 203a, 204a of input pipes 203, 204. The sealing member extends across the internal cross-sectional area of the housing so as to seal the distal part of the separation chamber with respect to the inlet pipe 104 from the off-gas. In this way the sealing member 290 forms an interior chamber 2000 in the same manner as outline above in FIG. 7. In this manner, the off-gas only enters the cyclonic chamber 205 via the input pipes 203, 204.

The sealing member 290 is shaped so as to divert the off-gas flowing from the inlet pipe 104 into the input pipes 203, 204, and so also acts as a distribution member. In the example of FIG. 8, the sealing member 290 comprises two angled facets 251, 252 in order to distribute the off-gas into the input pipes, but other shapes are envisaged that may perform this function.

Input pipes 203, 204 may comprise isolation valves 2030, 2040 as explained above in relation to FIG. 5B.

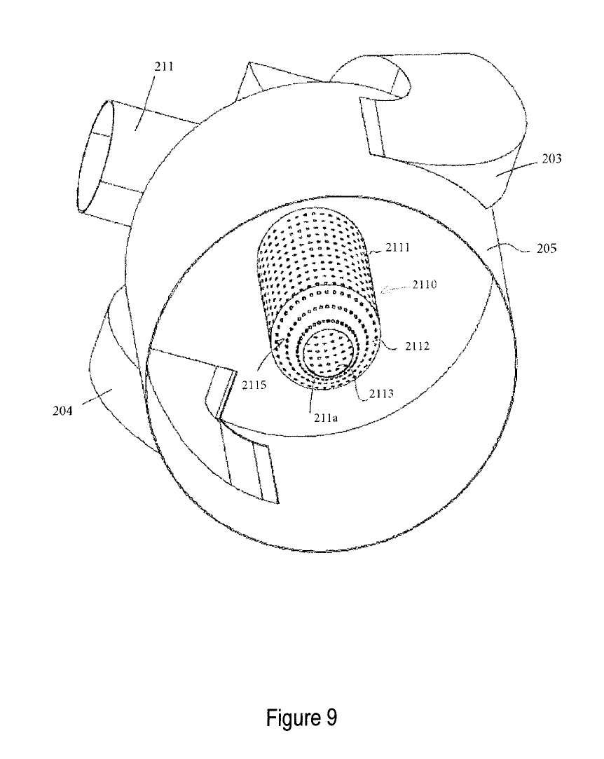

In all embodiments, the exit pipe 211 may optionally comprise a plurality of orifices in its walls. More specifically, as shown in FIG. 9, a first portion 2110 of the exit pipe, which is positioned within the cyclone chamber 205, may comprise said plurality of orifices. In the example shown in FIG. 9, the first portion 2110 comprises a main cylindrical section 2111, and a tapered section 2112 that defines a primary opening 2113 at the first end 211a of the exit pipe. Without the plurality of orifices (shown generally at 2115), the off-gas would exit the cyclone chamber through the primary opening 2113 at the first end 211a of the exit pipe.

However, in embodiments where the exit pipe comprises such a plurality of orifices 2115, some of the off-gas entering the cyclone chamber 205 (generally the gas that doesn't contain the dust particles at the chamber wall) may initially bypass the main body of the cyclone chamber 205 rather than forming a cyclonic flow. Therefore, by allowing some of the off-gas to be initially bypassed directly into the exit pipe through the orifices, the size of the cyclone chamber 205 can advantageously be reduced as less off-gas is required to be supported in cyclonic flow.

FIG. 9 illustrates orifices located so as to cover substantially the whole of the first portion of the exit pipe positioned within the cyclone chamber. However, in other embodiments the orifices may only cover a part of the exit pipe. In FIG. 9 the orifices are formed in a plurality of concentric rings, although other patterns may be used, such as a spiral pattern.

The orifices may have a size (e.g. diameter) in the range of 100 to 500 mm, preferably 200 mm.

In FIG. 9, the exit pipe is shown to comprise a main cylindrical section and a tapered part. However, the exit pipe may have other geometries, for example no tapered part.

As described above, the cyclonic adaptor 200 may comprise a plurality of different parts, including the attachment member 201, first and second input pipes 203, 204, cyclone chamber 205, cyclone shedder 209, exit pipe 211, bypass pipes 260, a sealing member 290 and distribution member 280. These may be integrally formed as a single unit or as a plurality of separate components that facilitate modular construction. In the case of an integrally formed single unit, the cyclonic adaptor would be designed according to the specifications of the dustcatcher in which it is to be fitted (for example with the required re-directing of the gas through the input and exit pipes as described above). For example, the attachment member 201 of the cyclonic adaptor of the first or second embodiments would be coupled to the inlet pipe of the dustcatcher and the exit pipe 211 of the cyclonic adaptor 200 coupled to the outlet of the dustcatcher. In order to fit the cyclonic adaptor to the top portion of the existing dustcatcher 100 would be temporality removed to facilitate installation of the cyclonic adaptor.

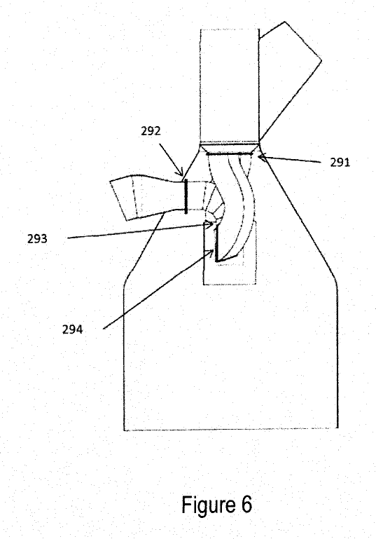

In the case where the cyclonic adaptor 200 comprises a number of separate parts, the parts may comprise flanges to assist in fitting the components together. Examples of such flanges are shown in FIG. 6. More specifically, the input pipes 203, 204 may be formed as a single unit comprising a flange 291 for coupling to the attachment member. Exit pipe 211 may comprise a flange 292 at a distal end with respect to the cyclone chamber for coupling to the outlet of the dustcatcher. The exit pipe may comprise a flange 293 at a proximal end with respect to the cyclone chamber for coupling the exit pipe to the top of the cyclone chamber. Each exit opening of the input pipes may comprise a flange 294 for tangential coupling to the side wall of the cyclone chamber. Further examples of flanges are shown at 295 in FIG. 5B, which aid in installation of the input pipes where the input pipes comprise a portion external to the dustcatcher.

Modular coupling of separate component parts in order to construct the cyclonic adaptor 200 may allow easier installation of the cyclonic adaptor within a conventional dustcatcher.

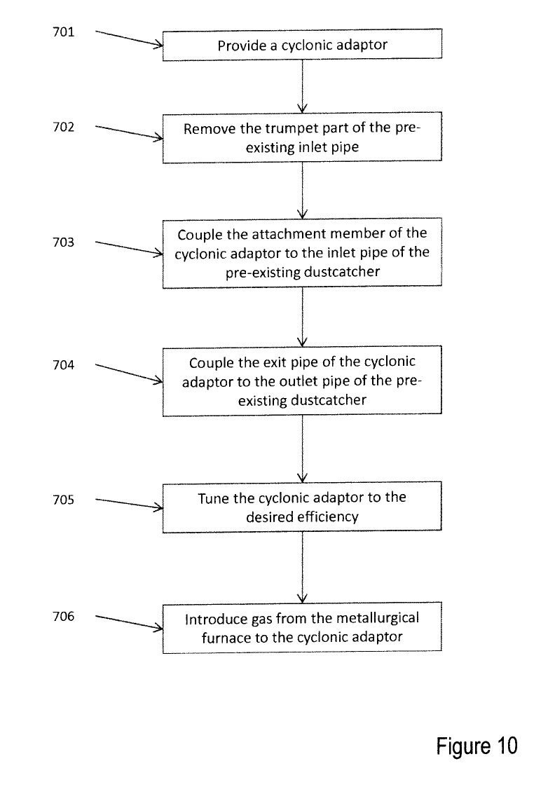

FIG. 10 is a flow diagram illustrating the steps of removing particulate matter from the off-gas from a metallurgical furnace according to an embodiment of the invention where the input pipe(s) of the cyclonic adapter are attachable to the inlet of the dustcatcher.

At step 701, a cyclonic adaptor is provided to the installation site, such as the cyclonic adaptor described above with reference to FIGS. 3 to 6. This may be an integrally formed unit or a series of separate parts that will require construction dependent on the installation site and the pre-existing dustcatcher to which the cyclonic adaptor is to be fitted. For example, if the installation site provides ample space around the dustcatcher, it may be possible to remove the top of the dustcatcher and install an integrally formed cyclonic adaptor. In a more confined scenario, a modular construction of the cyclonic adaptor may be required in which the cyclonic adaptor is installed in sections. More typically, due to the position of the downcomer, it is preferred to access the interior of the dustcatcher by removing a section of the side of the dustcatcher.

At step 702, the trumpet part of the pre-existing inlet pipe of the pre-existing dustcatcher is removed such that the attachment member of the cyclonic adaptor can be coupled to the cylindrical portion of the inlet pipe. However, dependent on the specifications of the pre-existing dustcatcher, a more suitable location for coupling the cyclonic adaptor to the dustcatcher may be available.

At step 703, the attachment member of the cyclonic adaptor is coupled to the inlet pipe of the pre-existing dustcatcher, typically by forming a welded joint. If the input pipes are adapted such that at least a portion of the input pipes is external to the dustcatcher, appropriate openings are made in the housing of the dustcatcher to accommodate the path of the input pipes.

At step 704, the exit pipe of the cyclonic adaptor is coupled to the outlet pipe of the pre-existing dustcatcher, again typically using welding. In addition a number of horizontal bracing struts or ties may be installed, by bolting or welding, between the cyclonic adaptor and the dustcatcher walls so as to prevent undesirable oscillation or vibration of the cyclonic adaptor when in use.

At step 705, the efficiency of the cyclonic adaptor is adjusted by coupling a bypass duct or a multiple of bypass ducts including valve(s) or blanking plate(s) or an adjustable orifice, to create a bypass route for dust in the upper section of the cyclone chamber 205 to be directly routed to the exit pipe 211. This allows the separation efficiency of the cyclone adaptor to be tuned/adjusted to achieve the desired separation efficiency.

Finally, at step 706, the system is placed into an operational state and the off-gas from the metallurgical furnace is introduced into the cyclonic adaptor through the pre-existing downcomer and inlet pipe as would be the case for the pre-existing dustcatcher.

It will be appreciated that steps 703 and 704 may be performed in the opposite order or simultaneously such that the cyclonic adaptor is successfully installed within the pre-existing dustcatcher.

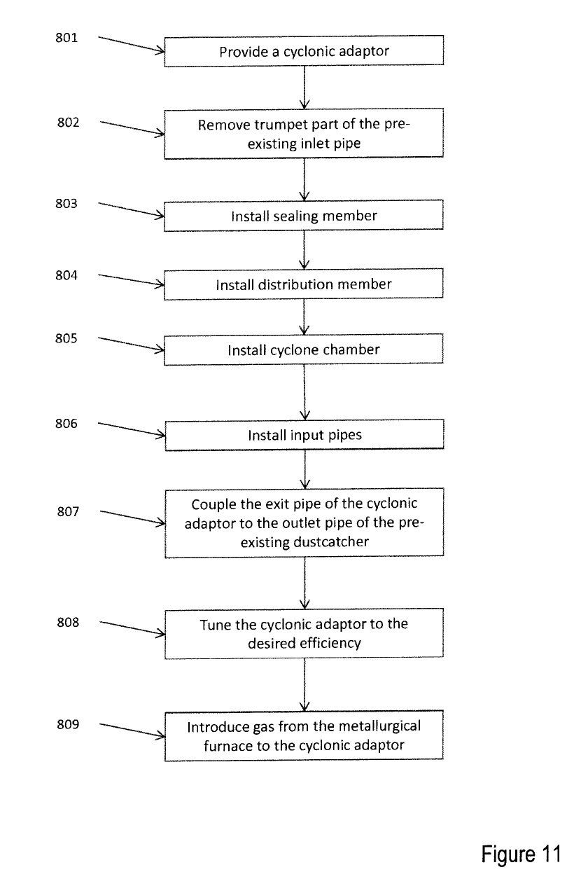

FIG. 11 is a flow diagram illustrating the steps of removing particulate matter from the off-gas from a metallurgical furnace according to an embodiment of the invention where the input pipe(s) of the cyclonic adapter are not attachable to the inlet of the dustcatcher.

At step 801, a cyclonic adaptor is provided to the installation site, such as the cyclonic adaptor described above with reference to FIGS. 7 and 8. This may be an integrally formed unit or a series of separate parts that will require construction dependent on the installation site and the pre-existing dustcatcher to which the cyclonic adaptor is to be fitted. For example, if the installation site provides ample space around the dustcatcher, it may be possible to remove the top of the dustcatcher and install an integrally formed cyclonic adaptor. In a more confined scenario, a modular construction of the cyclonic adaptor may be required in which the cyclonic adaptor is installed in sections. More typically, due to the position of the downcomer, it is preferred to access the interior of the dustcatcher by removing a section of the side of the dustcatcher.

At step 802, the trumpet part of the pre-existing inlet pipe of the pre-existing dustcatcher is removed to increase the amount of usable space within the interior volume of the dustcatcher, particularly such that the interior chamber may be formed.

At step 803, the sealing member is installed within the interior volume of the dustcatcher, so as to form the interior chamber. The sealing member is typically installed by forming a welded joint between the sealing member and the interior wall of the dustcatcher.

At step 804, the distribution member is installed. This may be attached to the sealing member by a welded join, for example. In other embodiments the sealing member and distribution member may be a unitary member.

At step 805, the cyclone chamber is installed. A number of horizontal bracing struts or ties may be installed, by bolting or welding, between the cyclone chamber and the dustcatcher walls so as to support the cyclone chamber and prevent undesirable oscillation or vibration of the cyclonic adaptor when in use.

At step 806, the input pipes are installed such that they extend between being in fluid communication with the interior chamber defined by the sealing plate, and the cyclone chamber. These may be attached to the sealing member (as seen in FIG. 7) or attached to appropriately formed openings in the housing of the dustcatcher, as seen in FIG. 8. In some embodiments, at least two of the sealing member, cyclone chamber and input pipes may be formed as a unitary member.

At step 807, the exit pipe of the cyclonic adaptor is coupled to the outlet pipe of the pre-existing dustcatcher, again typically using welding.

At step 808, the efficiency of the cyclonic adaptor is adjusted by coupling a bypass duct or a multiple of bypass ducts including valve(s) or blanking plate(s) or an adjustable orifice, to create a bypass route for dust in the upper section of the cyclone chamber 205 to be directly routed to the exit pipe 211.

This allows the separation efficiency of the cyclone adaptor to be tuned/adjusted to achieve the desired separation efficiency.

Finally, at step 809, the system is placed into an operational state and the off-gas from the metallurgical furnace is introduced into the cyclonic adaptor through the pre-existing downcomer and inlet pipe as would be the case for the pre-existing dustcatcher.

It will be appreciated that steps 803 to 806 may be performed in a different order or simultaneously such that the cyclonic adaptor is successfully installed within the pre-existing dustcatcher.

The methods set out in FIGS. 10 and 11 may be adapted accordingly for variations where the cyclonic adapter does not comprise an exit pipe (e.g. omitting the step of installing the exit pipe).

The cyclonic adaptor is installed such that the cyclone chamber is housed within the interior volume of the pre-existing dustcatcher, and is typically positioned such that dust particles removed from the cyclonic gas flow within the cyclone chamber are collected in the pre-existing collection hopper. Typically, the exit pipe of the cyclonic adaptor extends through the outer wall of the dustcatcher and couples with the pre-existing outlet externally to the dustcatcher. However, the exit pipe may be coupled to the pre-existing outlet within the interior volume of the dustcatcher, for example in furnace plant environment with limited working space around the existing dustcatcher.

In each of the embodiments described above, it is envisaged that a single input pipe, or more than two input pipes, may be used.

1-50. (canceled)

51. A cyclonic adaptor for fitting to a gravity-based dustcatcher for a metallurgical processing plant, comprising:
at least one input pipe, and;
a cyclone chamber having a curved inner surface for guiding a gas flow within the interior of the cyclone chamber in a cyclonic manner, the cyclone chamber comprising an exit in fluid communication with an outlet of the dustcatcher in use, wherein;
the at least one input pipe has a first end in fluid communication with an inlet of the dustcatcher in use and configured to receive exhaust gas containing solid particles from a metallurgical processing plant from the inlet of the dustcatcher, and the at least one inlet pipe extends from the first end to a second end positioned in fluid communication with the interior of the cyclone chamber, wherein;
the second end is arranged to direct the exhaust gas in an at least primarily tangential direction with respect to the curved inner surface of the cyclone chamber such that the exhaust gas entering the cyclone chamber flows in a cyclonic manner in order to remove solid particles from the exhaust gas before flowing through the exit;
an exit pipe having a first end positioned in fluid communication with the interior of the cyclone chamber and a second end in fluid communication with the outlet of the dustcatcher in use, wherein the second end of the exit pipe is attachable to an outlet of the dustcatcher and wherein the exit pipe forms the exit, and wherein;
the cyclone chamber is adapted to be housed within an interior volume of the dustcatcher.

52. The cyclonic adapter of claim 51, wherein the cyclone chamber is positioned substantially coaxially with the inlet of the dustcatcher.

53. The cyclonic adaptor of claim 51, wherein the second end of the at least one input pipe is positioned in fluid communication with the interior of the cyclone chamber adjacent the curved inner surface of the cyclone chamber.

54. The cyclonic adaptor of claim 53, wherein the second end of the at least one input pipe abuts the curved inner surface of the cyclone chamber.

55. The cyclonic adaptor of claim 51, wherein the first end of the at least one input pipe is adapted to receive exhaust gas containing solid particles from a metallurgical processing plant in an axial direction with respect to the cyclone chamber.

56. The cyclonic adaptor of claim 51, comprising two or more of the input pipes.

57. The cyclonic adaptor of claim 51, wherein the cyclone chamber comprises a substantially funnel-shaped chamber having a continuously-decreasing diameter such that an end of the cyclone chamber distal from the at least one input pipe has a smaller diameter than an end of the cyclone chamber proximal to the at least one input pipe, and wherein the funnel-shaped chamber further comprises an orifice at the distal end through which solid particles removed from the exhaust gas are guided.

58. The cyclonic adaptor of claim 51, further comprising at least one bypass pipe having a first end in fluid communication with the cyclone chamber and a second end in fluid communication with an outlet of the dustcatcher.

59. The cyclonic adaptor of claim 51, wherein the cyclone chamber and the at least one input pipe are adapted to be housed within an internal volume of the dustcatcher.

60. A method for removing solid particles from a metallurgical processing plant exhaust gas, the method comprising:
providing a cyclonic adaptor for fitting to a gravity-based dustcatcher for a metallurgical processing plant, the cyclonic adaptor comprising;
a cyclone chamber having a curved inner surface for guiding a gas flow within the interior of the cyclone chamber in a cyclonic manner, the cyclone chamber comprising an exit in fluid communication with an outlet of the dustcatcher in use;
at least one input pipe having a first end and a second end, the second end being in fluid communication with the interior of the cyclone chamber and arranged to direct exhaust gas in an at least primarily tangential direction with respect to the curved inner surface of the cyclone chamber, and;
an exit pipe having a first end positioned in fluid communication with the interior of the cyclone chamber and a second end in fluid communication with the outlet of the dustcatcher in use, and wherein the exit pipe forms the exit,
the method further comprising;
coupling the second end of the exit pipe to an outlet of the dustcatcher, and;
coupling the first end of the input pipe such that it is in fluid communication with an inlet of the dustcatcher and such that the cyclone chamber is housed within an interior volume of the dustcatcher and further such that;
flowing exhaust gas containing solid particles from the metallurgical processing plant flowing from the inlet of the dustcatcher and entering the cyclone chamber and flowing in a cyclonic manner in order to remove solid particles from the exhaust gas before flowing the exhaust gas through the exit pipe to the outlet of the dustcatcher.

61. The method of claim 60, further comprising the steps of:
providing at least one bypass pipe having a first end in fluid communication with the cyclone chamber and a second end in fluid communication with a portion of the exit pipe external to the cyclone chamber, the at least one bypass pipe comprising a valve operable to selectively control the gas flow impedance of the bypass pipe, and;
the method further comprising selectively actuating the valve of the at least one bypass pipe in order to control the size of solid particles removed from the exhaust gas.

62. The method of claim 61, wherein the selectively actuating of the valve is carried out based on data collected from the dustcatcher relating to the size of the solid particles being removed from the exhaust gas.

63. The method of claim 60, wherein the exit pipe is provided as a separate part, and the method further comprises the step of coupling the exit pipe to the cyclone chamber in order to form the cyclonic adapter.

64. A modified gravity-based dustcatcher for a metallurgical processing plant, the dustcatcher having an interior volume within which is located a cyclone chamber of a cyclonic adaptor according to claim 51, wherein the at least one input pipe of the cyclonic adaptor has a first end in fluid communication with an inlet of a dustcatcher.

65. The modified gravity-based dustcatcher of claim 64, wherein the second end of the exit pipe is coupled to an outlet of the dustcatcher.
